(19) United States
(12) Patent Application Publication
(10) Pub. No.: US 2006/0268706 A1
(43) Pub. Date: Nov. 30, 2006

(54) Method to measure the quality of a call connection set up from a mobile terminal

(76) Inventor: Benoit Gicquel, Le Pecq (FR)

Correspondence Address: PERMAN & GREEN, 425 POST ROAD, FAIRFIELD, CT, 06824, US

(21) Appl. No.: 11/367,016

(22) Filed: Mar. 2, 2006

(30) Foreign Application Priority Data
May 18, 2005 (FR) 05 51290

(51) Int. Cl. H04L 12/26

(52) U.S. Cl. 370/232

(57) ABSTRACT

In order to be able to manage a mobile telephony network with greater efficiency, the operator managing the network proposes to a section of his subscribers that they should fill in a form of appreciation after an attempt to set up a call connection. The responses entered into this form are associated with localization and time-related data to produce a message on quality that is sent to a processing server. In one variant, the message on quality also includes technical information produced during the call connection.

### BACKGROUND OF THE INVENTION

### Field of the Invention

An object of the invention is a method for measuring the quality of a call connection set up from a mobile telephone. The field of the invention is that of mobile telephony and more particularly that of the measurement of the quality of communications made from a mobile telephony terminal.

It is an aim of the invention to enable a mobile telephony operator to obtain localized appreciation or assessments from its subscribers on the basis of the most recent call connections.

In the prior art, there are known methods for testing the quality of a network. In these methods, checkers equipped with terminals are sent out to make calls in the zone for which an operator wishes to make measurements. Among the drawbacks of this procedure, there are at least three that are particularly disadvantageous. A first drawback is that the quality measured represents only one shot taken on a given measurement route: in fact, only the most accessible routes and places are measured and it is possible for the quality to deteriorate between two measurements. A second drawback of this testing procedure is that the calls made are standardized and the terminals of the checkers are over-used. In real life, calls do not all last two minutes and, furthermore, they are made with inter-call times that are variable and far greater that in the tests. In other words, the testing operator testing his network obtains the opinion of professionals whereas he seeks to know the views of his users. A third drawback of this testing mode is that the checkers make calls continuously: this has the effect of distorting their perception of quality. Indeed, making more than about 100 calls on the same day causes fatigue which adversely affects the perception of the quality of a call.

The testing techniques used are therefore poorly suited to the production of results that can be exploited by an operator to increase his customers' satisfaction rate.

The prior art also has known ways of making technical measurements on the network itself. These measurements are made by means of counters which, for example, count the number of calls, the number of hand-over operations, the number of interruptions, etc. This list is not exhaustive. The maximum precision of these counters is in the range of a quarter of an hour for one cell. Since most calls last less than one minute and may use several cells (for calls being made in conditions of mobility), these counters do not reflect the quality of a call connection. Another problem is that there are no counters available that can reproduce the audio quality of the call. Finally, it is not possible to agglomerate these measurements by counters to obtain an estimation of the perception of the quality of call connections for each type of mobile terminal.

The invention resolves these problems by a method wherein, after an attempt to set up a call connection or, if the call connection attempt has been successful, at the end of the call connection, it is proposed to the user of a terminal that he should fill in an electronic form of assessment or appreciation of the quality of the communication. An electronic form is, for example, a series of multiple-choice questions displayed successively on the screen of the terminal. The terminal stores the responses made to each question. This storage corresponds to a sequence of keys activated by the user when the electronic questionnaire is displayed. This stored sequence is the response of the user of the terminal to the electronic questionnaire. The questionnaire is electronic because it is implemented by the terminal, which is an electronic device. The response is sent by the terminal, through a message on quality (or quality message), to a server capable of processing these responses and especially capable of producing alert messages addressed to an action team. The alert messages depend on the content of the quality messages.

In one variant of the invention, the terminal records pieces of technical data during the attempt to set up the call connection and/or during any call connection that might follow the attempt. These pieces of technical data enable the server to judge the relevance of the responses to the electronic questionnaire and also correlate information with a user's perception of the quality of a call connection.

### SUMMARY OF THE INVENTION

An object of the invention therefore is a method for measuring the quality of a call connection set up from a terminal connected to a mobile telephony network, wherein:
the terminal detects an attempt to set up a call connection from or to said terminal,
at the end of the call connection or the attempt to set up a call connection, the terminal submits an electronic form to the user of the terminal, said form enabling entry of the user's appreciation of the call connection,
the terminal inserts information obtained from the filling-in of the form in a message on quality,
the terminal sends the message on quality to a telephony network management server.

Advantageously again according to the invention, the terminal inserts a piece of information on the localization of the terminal at the time of the call connection.

Advantageously again according to the invention, the terminal inserts a piece of information, in the message on quality, on the date of production of said message on quality.

Advantageously again according to the invention, the electrical form has a piece of information on the appreciation of the call connection by a user of the terminal according to which the call connection has or has not been successful and/or uninterrupted, the content of this field being inserted by the terminal into the message on quality.

Advantageously again according to the invention, the electronic form comprises a piece of information on the appreciation of the call connection by a user of the terminal, according to the user's perception on a scale comprising at least two levels.

Advantageously again according to the invention, the electronic form comprises a piece of information on the user's appreciation of the synchronization between sound and image during a videophone type call connection.

Advantageously again according to the invention, the electronic form comprises a piece of information on the situation of the terminal, whether it is outdoors, indoors with or without windows or on an upper floor level.

Advantageously again according to the invention, the terminal inserts pieces of technical information into the message on quality, these pieces of technical information relating to the call connection and being measured and recorded by the terminal during the call connection.

Advantageously again according to the invention, the pieces of technical information include an identifier of the model of the terminal.

Advantageously again according to the invention, the pieces of technical information are at least in the list formed by the following items: number of hand-over operations during the call connection, identifiers of the cells crossed during the call connection, average RXLEV level, average RXQUAL quality, MOS quantity, average time advance, percentage of FER rate over a given threshold, duration of the call.

Advantageously again according to the invention, the messages on quality are received and recorded in a server capable of producing alert messages as a function of the content of the messages on quality.

Advantageously again according to the invention, for the production of the alert messages, the server discards inconsistent messages on quality, an inconsistent message being identifiable at least according to one of the criteria in the following list: incompatibility between the technical measurements and the result given by the form, excessively high occurrence of negative messages on quality coming from a same subscriber, excessively large quantity of positive messages on quality coming from a same subscriber.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 illustrates means implementing the method according to the invention;

FIG. 2 illustrates steps of the method according to the invention;

FIG. 3 illustrates steps in the processing of a message on quality produced by the method according to the invention.

### MORE DETAILED DESCRIPTION

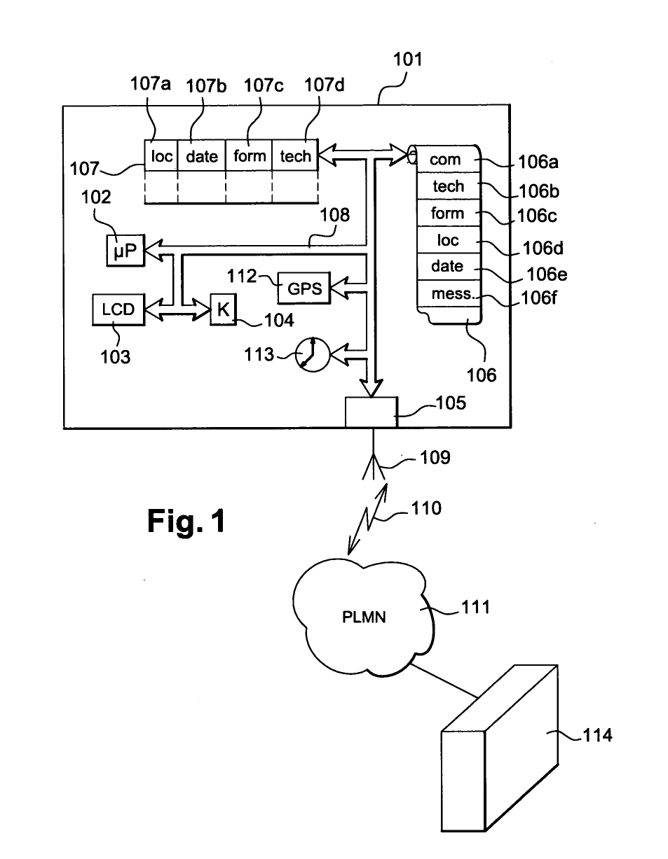

FIG. 1 shows a terminal 101 comprising a microprocessor 102, a screen 103, a keyboard 104, GSM circuits 105, a program memory 106 and a memory 107 of messages on quality (or quality messages). The elements 102 to 107 are interconnected by a bus 108.

In practical terms, when an action is attributed to a device, this action is performed by a microprocessor of the device commanded by instruction colds recorded in a program memory of the device.

The memory 106 is divided into several zones, each zone corresponding to instruction codes for the performance of a function of the device. The memory 106 has a zone 106a comprising instruction codes to implement a call connection, whether it is a voice, video or data connection. The memory 106 has a zone 106b comprising instruction codes to record technical data during the call connection. The memory 106 has a zone 106c for the presenting of an electronic form to a user of the terminal 101. The memory also has a zone 106b comprising instruction codes to produce localization information on the terminal 101. The memory 106 has a zone 106e comprising instruction codes to produce a date. The memory 106 also has a zone 106f comprising instruction codes to produce and send at least one message on quality.

The circuits 105 are connected to an antenna 109 used to set up an RF link 110 with a mobile telephony network. In the present example, the circuits 105 are deemed to be GSM type circuits driven by the instruction codes of the zone 106a. In practice, the circuits 105, and hence the instruction codes of the zone 106a, may correspond to another telephony standard from among the communications standards of the second generation, second-and-a-half generation or 2.5 G, third generation and future generations. In particular, the invention is quite applicable to the GPRS and UMTS standards.

The instruction codes 106d are used to produce a localization or information on location of the terminal. Such localization may be requested for example from the infrastructure of the network to which the terminal 101 is connected. The infrastructure then sends a localization in latitude and longitude. A localization may also be an identifier of a sector of a base station (or cell) to which the terminal 101 is connected when the request for localization is made. A localization may also be triangulated by the terminal 101 as a function of estimated distances to base stations which are within range of reception of the terminal 101. In yet another mode of production of localization, namely the mode that makes the invention most efficient, the terminal 101 is provided with GPRS circuits 112 connected to the bus 108. These circuits 112 are then interrogated by the microprocessor 102 implementing the instruction codes of the zone 106d.

The instruction codes of the zone 106e enable a date to be produced. In practice, either this data is requested from the infrastructure of the network by the terminal 101 or the terminal 101 has a clock 113 connected to the bus 108. The clock 113 is then interrogated by the microprocessor 102 commanded by the instruction codes of the zone 106e.

The memory 107 is used to record at least one message on quality (or quality message) produced by the terminal 101. A quality message has several fields, including at least one field 107a to record a piece of localization information or information on a location at which the message on quality was produced, one field 107b to record a date at which the quality message was produced and one field 107c to record the results of the electronic form resulting from the attempt to set up the call connection that prompted the production of the quality message.

Advantageously, the application for evaluating the quality on display of the questionnaire may also be integrated into a same card of the terminal.

The terminal 101 is, in practice, a mobile telephone capable of communicating on a mobile telephony network, whether it is network of the second generation, second-and-a-half generation, third generation or of a future generation.

FIG. 1 also shows that a server 14 is connected to the network 111 so as to receive the quality messages sent out by the terminals such as the terminal 101, namely terminals implementing the method according to the invention. The server 101 essentially comprises means for processing quality messages.

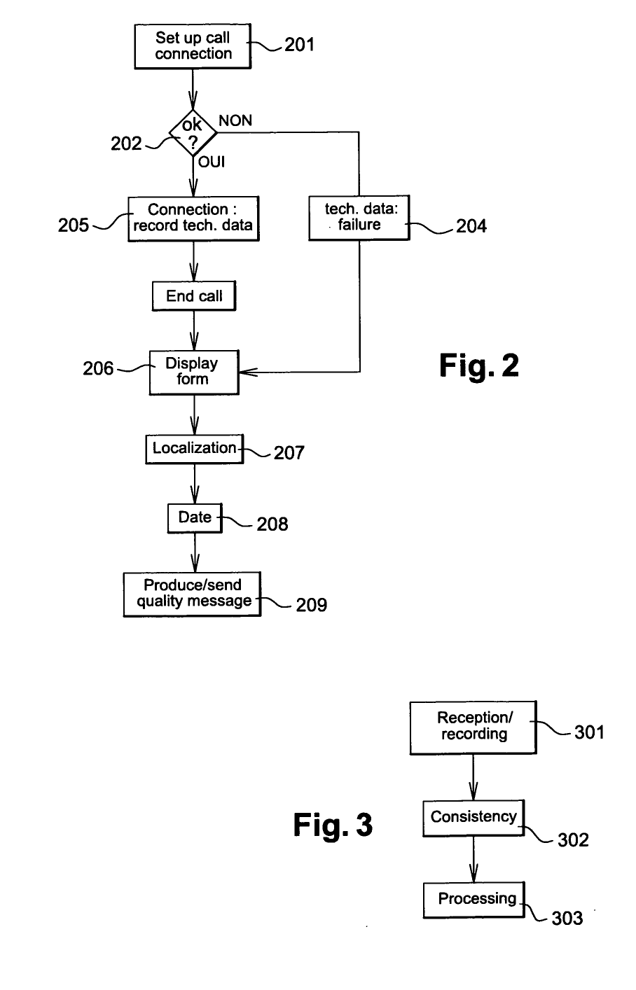

FIG. 2 shows a preliminary step to 01 in which the terminal 101 detects an attempt to set up a connection call. The terminal detects an attempt to set up a connection call in at least two circumstances. The first circumstance arises when the user of the terminal 101 tries to send out a voice, video or data call and, through the keyboard 104, enters an identifier of the terminal that he wishes to contact. The user then validates this entry. This prompts the attempt, by the terminal 101, to set up a call connection. The second circumstance arises when a distant user seeks to make contact with the user of the terminal 101. In this case too, the terminal 101 seeks to set up a call connection with the terminal of the distant user.

In the step 201, the terminal 101 initializes a quality message in the memory 107. Indeed, the memory 107 has at least all the quality messages that were not sent to the server 114 at the time of the attempt to set up a call connection corresponding to the step 201. The memory 107 is therefore liable to contain several quality messages. The initializing of a message consists in creating it in the memory 107. If this memory is seen as a table, with each column corresponding to a field, then the initialization is the creation of a vacant row in the memory 107.

From the step 201, the terminal 101 passes to a step 202 of branching, depending on the success or failure of the attempt to set up a call connection. In the event of failure, the terminal goes to a step 204. In the event of success, the terminal goes to a step 205.

In the step 205 the terminal 101 set up a classic call connection, for example a voice, videophone or data call connection depending on the user's needs when the call connection is set up. The type of call connection is chosen by the user through the keyboard 104.

In the step 205, and in a preferred variant of the invention, the terminal 101 performs measurements on the technical parameters of the call connection. The parameters measured are, for example:
the number of hand-over operations performed by the terminal 101 during the call connection, this number being directly related to the mobility of the user of the terminal 101;
the identifiers of the cells to which the terminal has got attached during the call connection;
the quantity RXLEV corresponding to the power level of the signals received by the terminal;
the quantity RXQUAL corresponding to the bit error rate at the terminal 101;
the quantity FER corresponding to the frame error rate at the terminal 101;
the quantity MOS corresponding to a synthesis of several physical quantities measured by the terminal 101;
the time advance (tm) imposed by the network on the terminal 101.

This list is neither exhaustive nor imperative. A particular implementation of the invention may consider only a subset of the technical parameters cited.

A useful piece of technical information relates to the model of the terminal 101. In practice, this model corresponds to a code recorded in the memory of the terminal 101 (based on the IMEI for the GSM). The terminal 101 reads this memory and writes the code read in the field 107d of the quality message created in the step 201.

When the user interrupts the call connection by activating the key intended for this purpose or when the call connection is interrupted for reasons independent of the user's will, the terminal 101 goes to a step 206 for displaying an electronic form.

In the step 204, the terminal 101 adds a piece of information to the technical information that was collected during the attempt to set up the call connection and has to be transmitted to the server 114. This added piece of information indicates that the attempt to set up the call connection has failed. This failure is due for example to the absence of a network. This absence then also corresponds to a technical measurement that is recorded in the field 107d of the quality message created in the step 201.

In the case of a data type call, the technical information also includes information on the quantity of data transferred. A data type of call is, for example, the retrieval or sending of an electronic message.

The technical information is recorded in the field 107d of the quality message created in the step 201.

From the step 204, the terminal 101 passes to the form display step 206. In a preferred example, an electronic form corresponds to a succession of multiple-choice questions put to the user of the terminal 101 through the screen 103. The user uses the keyboard 104 to respond to these questions. The sequence of keys activated by the user during the display of the electronic form constitutes the user's response to the electronic form. This response is recorded in the field 107c of the quality message created in the step 201.

In another variant, the form contains open-answer questions to which the user of the terminal can respond with a sentence. In this case again, the sequence of keys activated by the user during the display of the form constitutes the user's response to the form.

In practice, each response by the user is subjected to a validation process enabling the user to confirm his response and pass on to the next question in the form. After the last question in the form, the terminal 101 passes to a localization step 207.

An electronic form is implemented, for example, by an Internet navigator type application interpreting a file as a sequence of HTML instructions corresponding to the form. In another variant, the form is implemented through a Java or flash type application. In any case, the form or forms are recorded in the memory of the terminal 101. This memory is, for example, the zone 106c. This zone, or another one, also includes the instruction codes corresponding to the application that interprets the corresponding sequence of instructions in the form.

The form will not be the same, depending on the type of call connection made, or envisaged, by the user. The form presented to the user therefore depends on the type of call connection, but the principle of presentation and the response to the form remains the same in every case.

In the case of a voice connection, the electronic form comprises, for example, the following questions:
has the connection been successful and has it been uninterrupted ? The possible answers to this question are: 0=failed, 1=successful, 2=successful and uninterrupted. The user is therefore asked to activate one of the keys 0, 1 or 2 depending on whether the attempt to set up a connection call has failed, been successful without the possibility of his completing the conversation or else has been successful and uninterrupted. It will be noted that here, as in the case of the other questions the choice of the keys is arbitrary.
How would you grade the call connection? 0=poor, 1=acceptable, 2=perfect. The example chosen implements a three-level grading scale. Here, it is quite possible to have a narrower range for the grading: good or poor (two levels). It is also possible to have a wider range: very good, good, average, poor or very poor (5 levels). The number of levels in the appreciation scale is therefore left to the appreciation of the operator using the method according to the invention. A preferred embodiment uses an even number of levels, thus forcing the user to make a choice between good and poor.
How would you grade the audio quality? The possible answers here are the same as in the case of the previous question.

This list is neither exhaustive nor imperative.

In the case of a videophone type call, the electronic form furthermore comprises the following questions:
How would you grade the quality of the image?
How would you grade the sound/image synchronization?

The responses to these questions are the same as those described for the question on the overall appreciation of the call connection.

This list is neither exhaustive nor imperative.

In the case of a data type call, the electronic form furthermore comprises the following questions:
How would you grade the connection time?
How would you grade the transmission bit rate?

The responses to these questions are the same as those described for the question on the overall appreciation of the call connection.

This list is neither exhaustive nor imperative.

In one variant of the invention, the electronic form also has a question to situate the conditions of use of the terminal 101. The question is, for example: in what conditions did the call connection take place? The possible answers are then, for example: 0=outdoors, 1=indoors with window, 2=indoors without window, 3=from a upper floor.

The user's answers to these questions, or to a subset of these questions, are recorded in the field 107c of the quality message created at the step 201.

In the step 207, the terminal 101 interrogates the circuits 112 or equivalent localization means. The results of this interrogation are a latitude and longitude which are recorded in the field 107a of the quality message created at the step 201. From the step 207 in the terminal 101 goes to a dating step 208 in which the terminal 101 interrogates the circuits 113 or equivalent means. The result of this interrogation is a date that is recorded in the field 107b of the quality message created at the step 201. A date is preferably precise to within one minute. The invention remains relevant if the precision is to within one hour, 1 second, 1 millisecond or any other unit of measurement of time.

In practice, the steps 207 and can come into play at any time whatsoever in the attempt to set up a call connection or during the call connection. For example, the steps may be implemented just after the step 201 or N seconds after the step 201, N being for example included in the time span of [10 . . . 50] seconds.

Once the quality message created at the step 201 has been filled, i.e. once the fields 107a, 107b, 107c and, in one variant, the field 107d has been filled in by the terminal 101, said terminal sends the quality message to the server 114 in a step 209. A quality message is sent in data mode by SMS or by MMS. Once the message has been sent, the corresponding row in the memory 107 is eliminated. The sending of a message on quality is done through one or more frames of a given protocol, namely an SMS, MMS or TCP/IP protocol. These are frames whose data content is a row of the memory 107, i.e. pertaining to information that corresponds to a quality message.

It can happen that this operation of sending a quality message is not immediately possible. Instances of impossibility can arise, and these may include at least the following:
an attempt to set up a call connection in a zone not covered by the mobile telephony network,
an interruption of the call connection because of a loss of network followed by an impossibility of re-establishing connection with the network.

It will be noted here that these cases of detection are particularly interesting and undetectable in the prior art. Indeed, the invention make it possible therefore to map zones that are not covered by a telephony network and from which subscribers to this network need to send out calls. The invention even makes it possible to classify these zones as a function of the number of attempts made per zone to set up call connections.

In these cases, the quality messages corresponding to each attempt to set up a call connection are recorded in the memory 107 and sent one after the other, as soon as possible, to the server 114. This becomes possible again as soon as the terminal 101 is re-connected to a mobile telephony network. The sending of the quality messages is automated and does not require action by the user. In practice, the content of a row of the memory 107, corresponding to a quality message, is packaged in one or more frames and more particularly in the data part of said frame, of the communications protocol used to transmit the quality message. Such protocols are, for example, the SMS, MMS, or TCP/IP protocol. This list is not exhaustive. Such a frame comprises a header which itself comprises at least one identifier of the sender.

In the invention, while there necessarily has to be at least one attempt to set up a call connection in order that the form may be presented to the user, this presentation is not necessarily done systematically for each attempt to set up a call connection. Thus, the presenting of a form and hence the production and sending of a quality message are subjected to a period expressed either in time or in number of attempts to set up a call connection. For example, a maximum of one form per hour will be presented to the user. In another example, the form is presented at intervals of every three attempts made to set up a call connection. It is of course also possible to present the form each time there is an attempt to set up a call connection.

Finally, the customer may himself set the parameters for the periodicity, the activating fact or the time slot relating to his interrogation.

FIG. 3 shows a step 301 in which the server 114 receives a quality message produced by a terminal applying the method of the invention. The quality message is recorded, for archival storage, in a memory of the server 114 or in the memory to which the server 114 has access.

Once the quality message has been recorded, the server 114 goes to a consistency check step 302. A consistency check is done, for example, with respect to the customer's identity. The archival storage of the quality messages and the identifier contained in the header of the frame containing the quality message can indeed be used to associate a reliability grading with said identifier. This grading reflects the importance to be given to the content of the message. For example, if a user corresponding to an identifier sends back quality messages containing only poor grades, or quality messages containing only excellent grades, then it will no longer be relevant to take his quality messages into account.

Another relevance check is made, for example, on the ratio between the MOS or the FER and the customer's appreciation, or more generally on a possible major discrepancy between the customer's appreciation and the technical measurements. If the technical measurements show excellent results and if the customer's appreciation gives very poor grades, then the message is not relevant.

The messages deemed to be relevant are then processed in a step 303 by the server 114. A processing operation corresponds, for example, to the sending of an alert message to an action team. An alert message of this kind is sent, for example, if one or more negative opinions are received for a same geographical zone.

Another possible processing operation consists of the production of a report comprising an average of the appreciation results by brand and model of terminal.

With the invention, it is possible to determine what a positive perception on the part of the user corresponds to at the technical level. This makes it possible to optimize action on the network without seeking to obtain levels of technical performance not requested by the users.

As a replacement for field measurements, a testing campaign involving, for example, 30,000 terminals, would appear to be sufficient. The truly useful number of terminals to be tested will be given by statistical analysis on the first samples depending on the level of quality measured, unusable feedback from customers etc.

### Abbreviations

RXLEV: level of power on the GSM downlink radio channel (RSSI measurement of the field received, performed by the mobile telephone and encoded on six bits in steps of 1 db).

RSSI: qualitative measurement, performed by a receiver, of the field level received on a GSM channel.

RXQUAL: level of quality on the GSM downlink radio channel related to the transmission of the bits on the radio interface (measurement encoded on three bits pertaining to the quality of the received signal by estimation of the binary error rate BER enabling the C/I to be appreciated).

FER: the frame error rate (frames rejected after detection of errors).

MOS: quantity corresponding to a synthesis of several physical quantities measured by the terminal.

IMEI: international identity of a terminal. In the GSM, the first six bits (TAC) give the type of terminal.

“Hand-over”: mechanism by which a mobile can transfer its connection from one base station to another, or on in the same base station from one channel to another.

SIM: (USIM in the third generation) microcircuit card for insertion into a GSM terminal, containing at least all the subscriber information and, as the case may be, stored programs or files.

1. A method for measuring the quality of a call connection set up from a terminal connected to a mobile telephony network, wherein:
the terminal detects an attempt to set up a call connection from or to said terminal,
the terminal, at the end of the call connection or the attempt to set up a call connection, submits an electronic form to the user of the terminal, said form enabling entry of the user's appreciation of the call connection,
the terminal inserts information obtained from the filling-in of the form in a message on quality,
the terminal sends the message on quality to a telephony network management server.

2. A method according to claim 1 wherein the terminal inserts a piece of information on the localization of the terminal at the time of the call connection.

3. A method according to claim 1, wherein the terminal inserts a piece of information, in the message on quality, on the date of production of said message on quality.

4. A method according to claim 1, wherein the electrical form has a piece of information on the appreciation of the call connection by a user of the terminal according to which the call connection has or has not been successful and/or uninterrupted, the content of this field being inserted by the terminal into the message on quality.

5. A method according to claim 1, wherein the electronic form comprises a piece of information on the appreciation of the call connection by a user of the terminal, according to the user's perception on a scale comprising at least two levels.

6. A method according to claim 1, wherein the electronic form comprises a piece of information on the user's appreciation of the synchronization between sound and image during a videophone type call connection.

7. A method according to claim 1, wherein the electronic form comprises a piece of information on the situation of the terminal, whether it is outdoors, indoors with or without windows or on an upper floor level.

8. A method according to claim 1 wherein the terminal inserts pieces of technical information into the message on quality, these pieces of technical information relating to the call connection and being measured and recorded by the terminal during the call connection.

9. A method according to claim 8 wherein the pieces of technical information include an identifier of the model of the terminal.

10. A method according to claim 1, wherein the pieces of technical information are at least in the list formed by the following items: number of hand-over operations during the call connection, identifiers of the cells crossed during the call connection, average RXLEV level, average RXQUAL quality, MOS quantity, average time advance, percentage of FER rate over a given threshold, duration of the call.

11. A method according to claim 1, wherein the messages on quality are received and recorded in a server capable of producing alert messages as a function of the content of the messages on quality.

12. A method according to claim 11 wherein, for the production of the alert messages, the server discards inconsistent messages on quality, an inconsistent message being identifiable at least according to one of the criteria in the following list: incompatibility between the technical measurements and the result given by the form, excessively high occurrence of negative messages on quality coming from a same subscriber, excessively large quantity of positive messages on quality coming from a same subscriber.
